(19) United States
(12) Patent Application Publication
(10) Pub. No.: US 2006/0165207 A1
(43) Pub. Date: Jul. 27, 2006

(54) Commutator, gazelectrode, a method of electroplating and method ofinitiating cold fusion

(76) Inventor: John M Alder, Odenaarde (BE)

Correspondence Address: DLA PIPER RUDNICK GRAY CARY US LLP, 153 TOWNSEND STREET, SUITE 800, SAN FRANCISCO, CA, 94107-1907, US

(21) Appl. No.: 10/534,844

(22) PCT Filed: Nov. 13, 2003
(86) PCT No.: PCT/GB03/04940

§ 371 Date: Dec. 28, 2005

(30) Foreign Application Priority Data
Nov. 13, 2002 (EP) 024472193
Dec. 9, 2002 (GB) 02285732

(51) Int. Cl. H05H 1/22; C25D 5/00; C25D 17/00

(52) U.S. Cl. 376/100; 204/225; 205/80

(57) ABSTRACT

A commutator comprising a first and a second plate arranged to move relative to one another is provided. One of the plates comprises at least one input port arranged to allow a fluid to enter the commutator and one of the plates comprises at least one output port arranged to allow a fluid to exit the commutator. At least one of the plates comprises at least one connector, which is capable of connecting at least one input port to at least one output port. The plates are arranged such that the plates move relative to one another and the connector periodically connects the input port to the output port.

### PRIORITY

This application claims the benefit of priority to European application no. 02447219.3, filed Nov. 13, 2002, United Kingdom patent application no. 0228573.2, filed Dec. 9, 2002, and PCT application no. PCT/GB2003/004940, filed Nov. 13, 2003.

### FIELD OF THE INVENTION

This invention relates to a commutator, to circuits containing such a commutator and to methods of energy conversion. Particularly, but not exclusively, the invention relates generally to nuclear energy conversion, electrolytic circuits, and cells and more specifically to porous flow through electrodes.

### BACKGROUND

Many different types of electrolytic circuit and cells have been in use for many years and are currently in use for various applications from corrosion protection and material production which utilize electrolysis to batteries which are in everyday use which convert energy released from chemical reactions to electrical energy. Electrolysis cells utilizing porous flow through electrodes have been in use, for example, for the continuous analysis of liquid streams. All these techniques in this field in use so far make use of one or more of the following elements:
electrodes that provide an interface between an electrical circuit and an electrolyte normally with DC voltages being applied to them or DC voltages being generated between electrodes
an electrolyte, that is a solution containing a number of ionic species
a method of providing a steady continuous flow of electrolyte through or past an electrode or means of utilizing the flow of the electrolyte through or past an electrode—this commonly involves the use of porous flow through electrodes

With this combination of elements it has only proved possible to utilize energy released by chemical reactions or to control chemical reactions using electrical energy and all the prior art is concerned with these two processes. Cells have been proposed that make use of other elements for the purpose of conversion of nuclear fusion energy including types of porous electrodes used for “crowding of ions”. However the extra elements are exotic and expensive, none of the cells convert directly to electrical energy and none of the cells are in common use.

### SUMMARY OF THE INVENTION

According to a first aspect of the invention there is provided a commutator comprising at least a first and a second plate arranged to move relative to one another, one of the plates comprising at least one input port arranged to allow a fluid to enter the commutator and one of the plates comprising at least one output port arranged to allow a fluid to exit the commutator, and at least one of the plates comprising at least one connector, which is capable of connecting the at least one input port to the at least one output port, wherein the plates are arranged such that as the plates move relative to one another the connector periodically connects the input port to the output port.

An advantage of such an arrangement is that it can periodically connect the input port to the output port while simultaneously allowing fluid to pass through the commutator. By arranging the connector in an appropriate manner it is possible to control the flow of fluid through the commutator in a desired manner.

Conveniently, the plates are arranged such that they rotate relative to one another. Alternatively, or additionally, the plates may translate relative to one another.

The input port and the output port may be provided in the first plate and the connector may be provided in the second plate.

Conveniently one of the plates, generally the first plate, is held substantially stationary. Such an arrangement is convenient because it provides a stationary plate to which the input and output ports can be coupled.

One of the plates, generally the second plate, may be arranged to rotate relative to the other.

In one embodiment the input port comprises a hole passing through the first plate. Such an arrangement provides a simple arrangement allowing fluid to enter the commutator.

The connector may comprise a groove in the surface of the second plate, which in the preferred embodiment comprises a portion of a ring.

The first and second plate may be substantially circular and are preferably arranged to be held concentrically adjacent one another.

Preferably, the fluid comprises a liquid electrolyte. Such an arrangement in convenient for passing an electric current therethrough.

Conveniently, the commutator is arranged to allow an electric current to be passed through the fluid passing therethrough.

Preferably, the commutator comprises a means arranged to produce a signal indicating the relative position of the first and second plates. In the preferred embodiment the means comprises one or more Hall effect sensors and an associated magnet.

The commutator may be referred to as a liquid commutator.

According to a second aspect of the invention there is provided an electrolytic system comprising
a container for an electrolyte arranged such that the electrolyte forms an electrical circuit;
a commutator arranged to convert an AC electrical signal provided at a pair of input electrodes both immersed in the electrolyte to a DC signal at two points in the same electrolyte;
a controller for controlling the movement of the commutator and the waveform of the applied AC voltage such that the movement of the commutator and the voltage have a predetermined relationship; and
a set of working electrodes also provided within the electrolyte and arrange to pass a current therebetween.

The commutator may be the commutator of the first aspect of the invention. Alternatively, the commutator may be any of the other embodiments described herein.

Preferably, the system comprises a pump, which may be a pump, arranged to pump the electrolyte through the system. An advantage of the pump is that it helps to provide a smooth, controllable flow of electrolyte through the system.

The container will generally comprise a series of interconnected tubes. Conveniently, the ratio of the length of each tube to the cross sectional area is as large as possible. An advantage of a high ratio is that the electrical resistance provided by the electrolyte in the tube is consequently made as high as possible in order to minimise the initiation energy required to ignite reactions at the working electrodes.

The controller may be an electric/electronic circuit and in a preferred embodiment comprises at least one Hall effect sensor and an associated magnet means.

The controller may be arranged to generate a signal which is used to generate an AC voltage which is preferably synchronous with the movement of the commutator. The AC voltage may be applied to the input electrodes. An advantage of the commutator and controller running in this manner is that the effect of the applied AC voltage and the commutator is to produce a DC voltage at the output of the commutator.

The +ve end of this voltage is referred to, herein, as the “+ve virtual electrode” and the negative end as the “−ve virtual electrode”. This DC voltage is preferably applied across the working electrodes.

Preferably, any pump provided can be used to produce a steady flow of electrolyte from the +ve virtual electrode to the +ve working electrode and from the −ve virtual electrode to the −ve working electrode.

Flows from the working electrodes may be combined at the input of the pump.

The predetermined relationship between the AC voltage and the movement of the commutator may be to be in synchronism.

In one embodiment the commutator of the second aspect of the invention is that described in the first aspect of the invention.

The working electrodes may comprise a gas porous membrane. Such a membrane is advantageous because it allows gas generated at the electrode to escape therethrough and it therefore, may prevent the build up of gas at the working electrode.

Further, the working electrodes may be arranged such that ionic species within the electrolyte can be converted at the working electrodes such that the resulting faradaic current flowing in the electrolyte flows in the same direction as the flow of electrolyte within the container.

According to a third aspect of the invention there is provided a method of initiating a fusion reaction comprising:
providing a commutator allowing a fluid to pass therethrough;
applying an AC voltage to the fluid on the first side of the commutator;
providing a controller arranged to control the AC voltage such that it has a predetermined relationship to the movement of the commutator so as to generate a DC voltage in the fluid on a second side of the commutator; and
applying the DC voltage to a pair of working electrodes such that an electrochemical reaction is initiated therebetween with said electrochemical reaction establishing a fusion reaction.

It is thought that an advantage of such a method is that it can be used to initiate and sustain a fusion reaction.

According to a fourth aspect of the invention there is provided a method of plating a component comprising:
providing a commutator allowing a fluid to pass therethrough;
applying an AC voltage to the fluid on the first side of the commutator;
providing a controller arranged to control the AC voltage such that it has a predetermined relationship to the movement of the commutator so as to generate a DC voltage on a second side of the commutator; and
providing the component to be coated as at least one working electrode; and
applying the DC voltage to a pair of such working electrodes such that an electrochemical reaction is initiated therebetween with said electrochemical reaction causing the component to be coated.

According to a fifth aspect of the invention there is provided a commutator comprising a fluid input port, a fluid output port and a connector arranged to periodically connect the input port and output port.

According to a sixth aspect of the invention there is provided an electrode comprising an electrode conductor, a gas porous membrane associated with a porous backing such that a space is created that is capable of allowing a fluid to flow therein between the electrode conductor and the gas porous membrane.

The gas porous membrane may be mounted upon the porous backing.

The fluid is generally a liquid and in particular may be a liquid electrolyte.

The electrode may be a referred to as a working electrode herein.

### BRIEF DESCRIPTION OF DRAWINGS

There now follows by way of example only a detailed description of embodiments of the invention with reference to the accompanying drawings of which:

FIG. 1 shows a diagram representing the complete electrochemical circuit;

FIG. 2 shows an equivalent circuit in accordance with a preferred embodiment;

FIG. 3 shows a diagram representing a illustrative construction of working electrodes;

FIGS. 4a to 4e show diagrams representing the construction and operation of a liquid commutator in accordance with a preferred embodiment;

FIGS. 5a and 5b show voltage waveforms associated with a commutator; and

FIG. 6 shows a circuit suitable for allowing a commutator to provide the desired functionality.

### DETAILED DESCRIPTION OF THE PREFERRED EMBODIMENTS

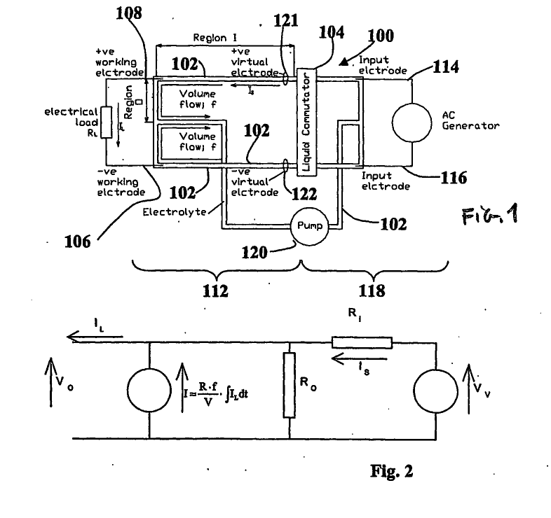

In one embodiment a system is provided which comprises a combined electrolytic/electric circuit being made up of the following elements and which are best seen in FIG. 1:
an electrically conductive circuit 100 which comprises a plurality of interconnected tubes 102 which provide a container and contain a conductive element which in this embodiment is a liquid electrolyte. The tubes 102 allow the electrolyte to flow between the other elements of the conductive circuit 100 as described hereinafter.
a commutator 104 providing a means of mechanically switching the electrolyte circuit in synchronism with an applied AC voltage, which will be described hereinafter.
a pair of working electrodes 106,108 immersed in electrolyte in a vessel 110 on an output side 112 of the electrically conductive circuit 100 (to the left of the commutator in FIG. 1).
a pair of input electrodes 114,116 immersed in the electrolyte to which the AC voltage is applied on an input side 118 of the electrically conductive circuit 100 (to the right of the commutator in FIG. 1).

A pump 120 (which in this example is a pump) arranged to pump the electrolyte through the commutator 104 towards the working electrodes 106,108. In one embodiment, the pump includes of a pulsating metering pump and a condenser to provide a smooth controlled flow.

The ratio of the length of each section of tube 102 to the cross sectional area is as large as is conveniently possible to maximise the electrical resistance that the electrolyte presents to the electrode pairs (working electrode pair 106,108 and input electrode pair 114,116).

FIG. 3, shows a suitable design for the working electrodes. Each electrode 106,108 comprises a conductor 300, the material of which is able to withstand the conditions at the electrode surface and is unaffected by the electrolyte. A gas porous membrane 302 is provided adjacent the electrode conductor 300 such that a space 304 is provided between the two allowing electrolyte to flow therebetween. A stiff perforated backing 306 is provided on a back surface of the gas porous membrane (on the opposite side thereof to the electrode conductor 300) and provides mechanical support for the gas porous membrane 302.

The gas porous membrane 302 is used to remove any gases produced by reactions occurring at the electrode surface of the electrode conductor 300. The rate of gas production may require a near vacuum to be maintained on one side of the gas porous membrane 302 to enable gases to be pumped out. The stiff perforated backing 306 is used to hold the membrane close against the electrode conductor 300, which is in made from metal in this embodiment.

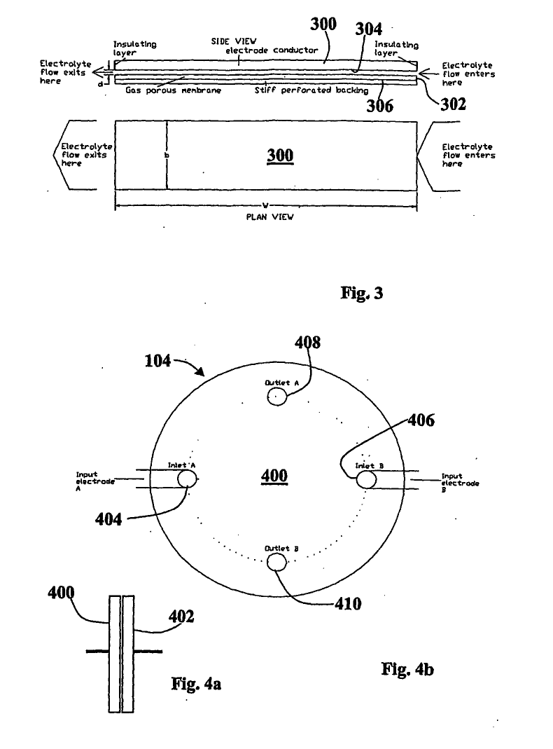

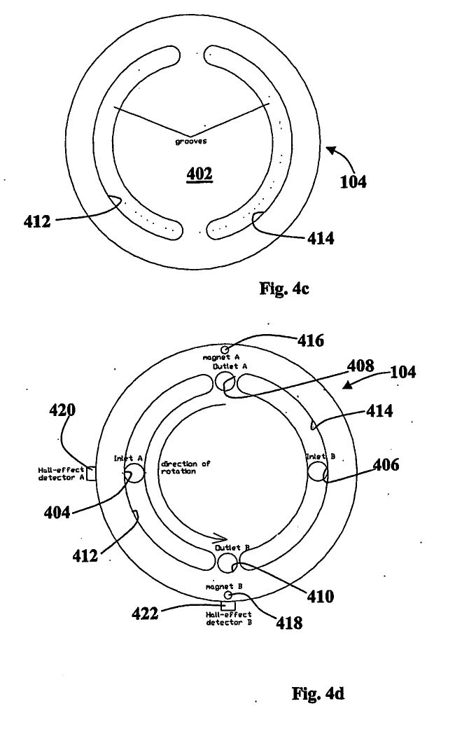

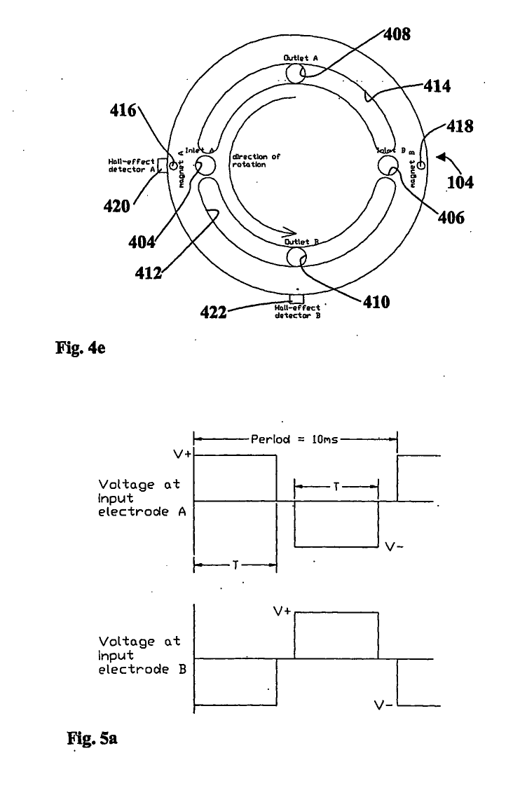

Turning to FIGS. 4a to 4d which show a suitable design for the commutator 104 which consists of first 400 and a second plate 402 plate held against each other as shown in FIG. 4a (which shows a side elevation of the arrangement) with one plate 402 rotating (the rotating plate) the other 400 fixed (the fixed plate). The fixed plate 400 has four holes, inlet A 404 and inlet B 406 allowing the electrolyte to flow into the commutator 104 and providing input and outlet A 408 and outlet B 410 allowing the electrolyte to flow out of the commutator 104 and providing an output. Each inlet 404,406 is connected, via the electrolyte, to an input electrode 114,116. For example inlet A 404 to the input electrode 114 and inlet B 406 is connected to the input electrode 116. The arrangement of the holes in the fixed plate 400 and the connections to the input electrodes 404,406 are explained hereinafter.

The rotating plate 402 has a first 412 and a second 414 groove in the surface that is held against the fixed plate 400. These grooves do not pass entirely through the plate 402, but are merely depressions therein and provide a connector. These grooves 412,414 are filled with electrolyte so that, when one of the grooves 412,414 simultaneously covers an inlet 404,406 and an outlet 408,410, the inlet 404,406 and outlet 408,410 are connected via the electrolyte by a low electrical resistance. Otherwise, the inlets 404,406 and outlets 408,410 are connected via a high resistance film of electrolyte between the plates 400,402. As can be seen from FIG. 4c a suitable pattern for each of the first 412 and second 414 grooves comprises a roughly 160° portion of a ring co-centric with the centre of the plates 400,402.

A means is provided to measure the rotational position of the rotating plate 402 and to generate a signal which is used to generate an AC voltage which is synchronous with the movement of the commutator 104 and which is applied to the input electrodes 114,116. In one embodiment, the means that is provided to measure the rotational position of the rotating plate 402 comprises magnets 416,418 are placed on the rotating plate 402 and hall-effect devices 420,422 are placed on the fixed plate, at a 90° displacement to each other relative to the plates 400,402, in order to detect the position of the rotating plate 402 relative to the fixed plate 400. In other embodiments the means provided to measure the rotational position of the rotating plate 402 may be other than Hall effect detectors and may for example be any of the following (which is not intended to be an exhaustive list, but is provided for example only): an optical pickup, a stepper motor, a mechanical switch/contact, or the like.

To explain the operation of the commutator 104 the electrical connections through the commutator 104 are described as the rotating plate 402 moves in relation to the fixed plate 400. However, the effect of the applied AC voltage and the commutator 104 is to produce a DC voltage at the output of the commutator 104 at virtual electrodes 121,122 (as shown in FIG. 1).

FIG. 4d (which for convenience shows the position of elements with respect to one another even though some elements would be obscured from view) gives the position of the hall-effect detectors 420,422 on the fixed plate 400, the magnets 416,418 on the rotating plate 402 and the grooves 412,414 at the point in the cycle when the voltage applied to input electrode 114 connected to inlet A 404 is changing from a negative voltage V− to an equal and opposite positive voltage V+ and the voltage applied to input electrode 116 connected to inlet B 406 is changing from V+ to V−.

An electronic circuit is connected between the hall-effect sensors 420,422 and the input electrodes 114,116 so that when a signal is output from detector B 422 the voltage applied to input electrode 116 connected to inlet A 404 is switched from V− to V+ and that applied to input electrode 116 connected to inlet B 406 from V+ to V−. For the following (π/2−Δ) radians of rotation of the rotating plate 402 the grooves 412,414 are in a position in which inlet A 404 is connected to outlet B 410 through the electrolyte and inlet B 406 is connected to outlet A 408 through the electrolyte. This means that the voltage in the electrolyte at outlet B 410 is approximately V+ and the voltage at outlet A 408 is approximately V− while inlet A 404 and outlet B 410 are connected together and inlet B 406 and outlet A 408 are connected.

FIG. 4e (which, again, for convenience shows the position of elements with respect to one another even though some elements would be obscured from view) gives the relative positions when the voltage applied to input electrode 114 connected to inlet A 404 is changing from V+ to V− and the voltage applied to input electrode 116 connected to inlet B 406 is changing from V− to V+.

When a signal is output from detector A 420 the electronic circuit switches the voltage applied to input electrode 114 connected to inlet A 404 from V+ to V− and that applied to the input electrode 116 connected to inlet B 406 from V− to V+. For the following (π/2−Δ) radians of rotation of the rotating plate 402 the grooves 412,414 are in a position in which inlet A 404 is connected to outlet A 408 through the electrolyte and inlet B 406 is connected to outlet B 410 through the electrolyte. This means that the voltage in the electrolyte at outlet B 410 is approximately V+ and the voltage at outlet A 408 is approximately V− while inlet A 404 and outlet A 408 are connected together and inlet B 406 and outlet B 410 are connected. After the rotating plate 402 has rotated a further π/2 radians from this position the grooves 412,414 are in the same position as in FIG. 4D and the cycle repeats.

In one embodiment, the rotating plate 402 is driven by an AC induction motor rotating at just under 3000 rpm. This means that the voltage applied to the input electrodes 114,116 takes the form as given in FIG. 5a (T=5.(1−(Δ/π))ms). It can be seen that the voltages at the inlets 404,406 are a square wave approximation to a Sine wave; i.e. a positive square wave of period T, followed by a negative square wave of period T, with a short period (relative to the period of the waves) between the positive and negative square waves.

The resulting voltages appearing in the electrolyte at outlet A 408 and outlet B 410 are given in FIG. 5b. It can be seen that the voltage appearing at outlet B 410 comprises a series of positive square waves, and that the voltage appearing at outlet A 408 comprises a series of negative square waves.

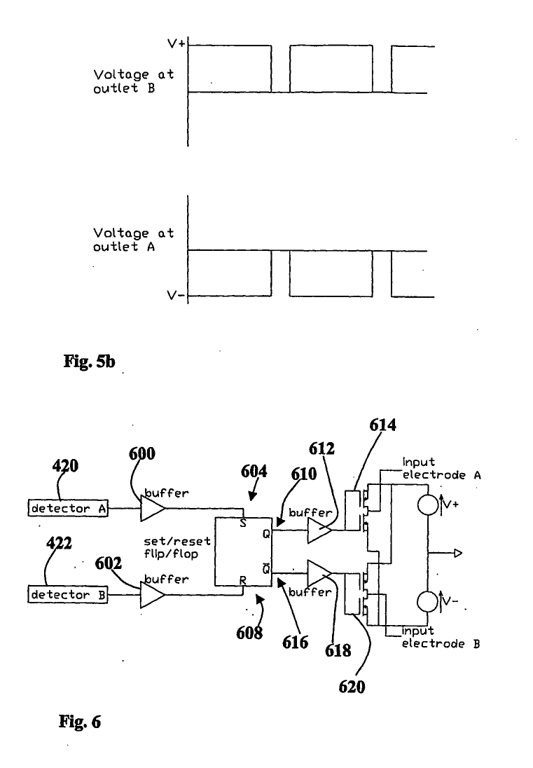

A suitable circuit connected between the hall-effect detectors and the input electrodes is given in FIG. 6 and provides a controller arranged to maintain the applied AC voltage and the position of the plates in a predetermined manner. The output of the Hall effect detector A 420 is input to a first buffer 600 and the output of the Hall effect detector B 422 is input to a second buffer 602. The output of the first buffer 600 is connected to the Set (S) input 604 of an SR flip flop 606 and the output of the second buffer 602 is connected to the reset (R) input 608 of the SR flip flop 606. The output 610 of the flip flop 606 is buffered by a third buffer 612 which drives a switch 614 arranged to drive the input electrode A 114. The NOT output 616 of the flip flop 606 is buffered by a fourth buffer 618 which drives a switch 620 arranged to drive the input electrode B 116. The switches 614,620 may be any suitable electronic switches such as FET's MosFET's, or the like.

The waveforms of FIG. 5a are AC waveforms; that is there is no DC content so there will be no electrochemical reactions occurring at the input electrodes. This is providing the frequency is high enough. With the rotating plate of the commutator rotating at 3000 rpm the frequency is ≈100 Hz which is high enough so that no reactions will occur. Elements may be added to the circuit, such as a transformer at the output 406,408, so that it is impossible for any DC voltage to be applied to the input electrodes 114,116. From the waveforms given in FIG. 5b outlet B 410 is the +ve virtual electrode 121 (connected to the +ve working electrode 108) and outlet A 408 is the −ve virtual electrode 122 (connected to the −ve working electrode 106). Thus, the DC voltage produced by the commutator 104 is applied across the working electrodes 106,108. It should be noted that this DC voltage is generated within the electrolyte without there being a corresponding electrochemical reaction.

The pump 120 is used to produce a steady flow of electrolyte from the +ve virtual electrode 121 to the +ve working electrode 108 and from the −ve virtual electrode 122 to the −ve working electrode 106. These flows are combined at the input of the pump 120. With an electrical load connected between the working electrodes 106,108 the effect of the applied AC voltage and the volume flow of the electrolyte is to produce a constant current source between the working electrodes 106,108.

The magnitude of the current is only dependent on the volume flow rate and the ion concentration in the electrolyte. It is independent of the magnitude of the applied AC voltage and the magnitude of the electrical load. With this current flowing the limiting voltage between the working electrodes is very high.

A consideration of the thermodynamics of the electrode/electrolyte interface at the working electrodes 106,108; that is the conditions when no current is being generated in the external electrical load; indicates that very high partial pressures are present at the interfaces between the working electrodes 106,108 and the electrolyte. These pressures are such that it is expected that the solution at these interfaces will change state and will take the form of a plasma. A consideration of the possible electrochemical reactions at the working electrodes (as discussed hereinafter) indicates that energy may be derived from the system without there being a net change in the chemical state of the system. This means that the sources of the energy are nuclear reactions occurring at the working electrode/electrolyte interfaces. These reactions are not fission reactions involving heavy atomic weight elements, since energy is released without these elements being present, they are fusion reactions since only light or medium atomic weight elements are present that may combine in fusion reactions, releasing energy in the process. As well as energy conversion, an apparatus in accordance with a preferred embodiment may be used to coat the surfaces of the working electrodes with material under conditions of very high pressures and room temperature. A system in accordance with one embodiment may be considered as a system for igniting and controlling nuclear fusion reactions either for direct conversion to electrical energy or for the production of materials under conditions of very high pressure and normal temperature.

The separate commutator 104 and pump 120 constitute one possible embodiment. In another possible embodiment they are combined. The commutator consists of a set of 4 paddles attached to a vibrating beam. For part of the cycle of movement of the paddles the paddles are pressed against a surface providing a break in the conductive path for the electrolyte. If the paddles are positioned at the correct points on the beam the relative phases of movement of the paddles will be such that the cycle of conductive and non-conductive periods will be as for the commutator just described so that if an AC voltage is applied to a pair of input electrodes this AC voltage will be converted to DC at the outlets. The relative phases of movement of the paddles are such that the electrolyte is pumped from the inlets to the outlets.

The electrochemical reactions are described in terms of general redox reactions; that is, in terms of species O in solution being reduced to species Rⁿ⁻ and species R in solution being oxidised to species Oⁿ⁺. Reference is made to FIGS. 1 and 3.

At the +ve working electrode 108 species O is entering the electrode 108 and being converted to R in the reaction O+n.e⁻→Rⁿ⁻ and at the −ve working electrode 106 R is entering the electrode 106 and being converted to O in the reaction R-n.e⁻→Oⁿ⁺. The conversion efficiency of the electrodes 106,108 may be defined as for a normal porous flow-through electrode as:

$$R = 1 - \frac{C ( out )}{C ( in )}$$

C(out) is the concentration of the active species leaving the electrode and C(in) the concentration entering the electrode.
The following argument deriving an estimation of the conversion efficiency and limiting current of the electrode assembly of FIG. 3 is based on that given in (ref. 1.).
Considering a random walk of an ion, an estimate of the average distance moved by an ion in time t is:
x=\sqrt{2·D·t}
D is the diffusion constant of the ion.
This means that an estimate of the time taken for an ion to diffuse from the restrictor wall to the electrode is:

$${τ}_{D} = \frac{{d}^{2}}{2 \cdot D}$$

d is the dimension given in the FIG. 3.
The average transit time of an ion across the face of the electrode is

$${τ}_{t} = \frac{d \cdot W \cdot b}{f}$$

f is the volume flow rate of the electrolyte and W and b are the dimensions given in FIG. 3.
Following the same reasoning as in (Ref. 1) if τₜ>t_{D} the conversion efficiency will be high (R≅1). This is equivalent to the condition:

$$f < \frac{2 \cdot D \cdot W \cdot b}{d}$$

Under these conditions the limiting current will be:
i_{Lim}≅Cₒ·F·n·f
Cₒ is the concentration of the reacting species in the electrolyte being fed to the electrode, F is Faraday's constant and n is the number of charges on the ion.
With a DC voltage being applied to a pair of input electrodes instead of the present input electrode 114,116/commutator 104 combination the current I_{L} into the +ve input electrode 108 this will be producing charge Q_{I} and the reduced species Oⁿ⁺ at the rate of:

$${I}_{L} = \frac{ⅆ {Q}_{I}}{ⅆ t} = \frac{n \cdot F \cdot ⅆ {O}^{+}}{ⅆ t}$$

The reaction at the electrode will be R-n.e⁻→Oⁿ⁺ and this charge will be entering the region of the electrolyte I.
Up to the limiting current the current I_{L} flowing out of the +ve working electrode will be producing charge Qₒ and the oxidised species Rⁿ⁻ at the rate of:

$${I}_{L} = - \frac{ⅆ {Q}_{I}}{ⅆ t} = - \frac{n \cdot F \cdot ⅆ {R}^{n -}}{ⅆ t}$$

Oⁿ⁺ and Rⁿ⁻ in the last two equations are molar concentrations of the species.
The increases in the concentrations dRⁿ⁻ and dOⁿ⁺ produce equal and opposite incremental currents in the region O of the electrolyte so there is no net charge entering this region.
Since, with an AC voltage applied to the input electrode/commutator combination as described herein non of the reduced species Oⁿ⁺ is being produced at the +ve input electrode a net charge Q=R×I_{L}dt will be entering the region O and the current I_{S} is a migration of ions due to a voltage gradient. This charge will be −ve since, as with a normal flow electrolysis electrode, the reaction O+n.e⁻→Rⁿ⁻ is occurring, O is entering the electrode assembly and an increase in Rⁿ⁻ is leaving the assembly. Because this charge is moving in the same direction as the volume flow of the electrolyte and the charge is negative it constitutes an electric current in the opposite direction of the volume flow as given in FIG. 3. This current is in the same direction as the current in the external electrical load.
The value of this current is:

$$I = \frac{R \cdot f}{V} \cdot \int {I}_{L} ⅆ t$$

V is the volume of the region O.
With the AC voltage being applied and without the volume flow of the electrolyte the current Is will be made up of a flow of Rⁿ⁻ being produced at the +ve working electrode and flowing towards the +ve virtual electrode and this current will be adding to the other migration currents caused by the voltage gradient.
From this consideration of the currents in the arrangement the equivalent circuit shown in FIG. 2 may be constructed:
Summing the currents at the +ve working electrode:

$$\frac{( {V}_{v} - {V}_{O} )}{{R}_{I}} - \frac{{V}_{O}}{{R}_{O}} + \frac{R \cdot f \cdot {V}_{O}}{s \cdot V \cdot {R}_{L}} - \frac{{V}_{O}}{{R}_{L}} = 0$$

s is the Laplace transform variable replacing the integration and V_{O} and V_{V} are the Laplace transforms of these variables. In the time domain if V_{V} is a unit step function V_{O} is:

$$\begin{matrix}{V}_{O } = \frac{{V}_{v} \cdot {R}_{O} \cdot {R}_{L}}{( {R}_{O} \cdot {R}_{L} + {R}_{I} \cdot {R}_{L} + {R}_{I} \cdot {R}_{O} )} \cdot \\ exp ( \frac{R \cdot f \cdot {R}_{O} \cdot {R}_{I} \cdot t}{V \cdot ( {R}_{O} \cdot {R}_{L} + {R}_{I} \cdot {R}_{L} + {R}_{I} \cdot {R}_{O} )} )\end{matrix}$$

It should be noted that if R_{O} in this equation for the output voltage of the equivalent circuit is infinite and the R_{I} is zero the time taken for the output current to reach the limiting value is minimised. In other words if the resistance between the positive and negative electrode sets (i.e. the resistance between the +ve and −ve working electrode and between the +ve and −ve input electrode) is maximised compared to the resistances between the virtual and working electrodes within the sets the energy required to ignite the reactions at the working electrodes is minimised.
This indicates that the voltage at the working electrodes will rise exponentially until it is limited by a combination of the limiting current and the load resistance. The time taken to reach the limiting current will be:

$$\begin{matrix}T = \frac{V \cdot ( {R}_{O} \cdot {R}_{L} + {R}_{I} \cdot {R}_{L} + {R}_{I} \cdot {R}_{O} )}{R \cdot f \cdot {R}_{O} \cdot {R}_{I}} \cdot \\ Log n ( \frac{{I}_{Lim} \cdot ( {R}_{O} \cdot {R}_{L} + {R}_{I} \cdot {R}_{L} + {R}_{I} \cdot {R}_{O} )}{{V}_{v} \cdot {R}_{O} \cdot } )\end{matrix} `$$

Under steady state conditions the circuit looking into the working electrodes is a constant current source with a very high source voltage. The value of the current is not a function of the AC voltage at the input electrodes it is just a function of the volume flow rate of the electrolyte and the concentration of the active species. With no load current V_{O} is stable at:

$${V}_{O} = \frac{{V}_{V} \cdot {R}_{O}}{( {R}_{O} + {R}_{I} )}$$

This means that a reaction may be “ignited” at the working electrodes producing a constant current source which may be extinguished either by cutting off the external electrical load or by stopping the volume flow of the electrolyte.
As an example, if the electrolyte is an aqueous solution of sodium hydroxide the reaction at the +ve working electrode will be:
2H₂O+2e⁻→2OH⁻+H₂
the reaction at the −ve working electrode will be
4OH⁻−4e⁻→2H₂O+O₂
and the current in region O due to the volume flow will be due to excess OH⁻ ions. Note that because these reactions produce gases and in the arrangement of the working electrodes shown in FIG. 3 it is the porous membrane that is used to extract the gases. This might be useful if the gases produced are a useful or desired product of the reactions. If the object is energy conversion then a more appropriate set of reactions may be the release and absorption of Li+ ions at graphite electrodes as used in the Li ion cell. In this case the porous membrane is not necessary since there are no gases given off and the electrode assembly may be realised by sandwiching an electrically isolating sheet between two graphite electrodes. The solution would be a simple salt of lithium—say LiS—in an organic solvent.
In a normal electrolytic cell the voltage appearing spontaneously, between a pair of electrodes under equilibrium conditions is the difference between the formal half cell potentials, E^{o}, for each of the electrodes. “Equilibrium conditions” here, means that at every electrode/electrolyte interface in the cell there are no “net” reactions occurring of the type O+n.e⁻→Rⁿ⁻. This means that the reaction is in balance; that is, the reactions in the forward direction O+n.e⁻→Rⁿ⁻ and reverse direction
O+n.e⁻←Rⁿ⁻ are occurring at an equal and opposite rate and the net reaction is zero. Under these conditions, the equation giving the formal half cell potential at each electrode is the Nernst equation:

$$E = {E}^{O} + \frac{R \cdot T}{n \cdot F} \cdot Log n ( \frac{O}{R} )$$

and the potential difference between any two electrodes is the difference in these potentials for the two electrodes. O and R in the equation are the relative concentrations of the species O and R taking part in the reaction. In a normal electrolytic cell the ratio of these concentrations is given by the relative numbers of moles of O and R taking part in the reaction and E^{O} is the (Gibbs free energy of the reaction) X n X F so that the potential differences between any two electrodes is defined by the electrochemical reactions that may occur at the electrodes. With the cell described herein, this is not the case. Under equilibrium conditions the voltage appearing between the working electrodes is defined by the applied AC voltage and the relative resistances of the branches in the electrolytic circuit. Assuming that, under equilibrium conditions, only reactions of the type O+n.e⁻→Rⁿ⁻ are occurring at the electrode/electrolyte interface E^{O} in the equation cannot be more than a few volts since it relates to the Gibbs free energy of the reaction. This means that the difference has to be made up in the ratio of the concentrations (O/R). This is so because the difference cannot be made up from an increase in temperature T since this would mean a net power input into the system and under ideal conditions; that is, with very large electrical resistances through the electrolyte and negligible mechanical and electrical losses through the commutator; there is no energy input producing the voltage. Calculating the ratio (O/R) for a modest voltage difference of, say, 30V, gives a value for the ratio of the concentrations which is very large and which indicates that there is no R present in comparison to the amount of O present at the electrode/electrolyte interface. This may be explained if O is a positively charged species because there will be a certain charge distribution on the surfaces of the working electrodes due to the different potentials at the electrodes. Without the volume flow of the electrolyte, when a current flows in the external electrical load, O at the surface of the electrode is converted to R, the concentration of R increases, the concentration of O decreases and the voltage difference between the two working electrodes is determined partly by the Nernst equation, partly by the rates of the reactions at the electrodes and partly the supply of O to the working electrode determined only by the migration of O due to electric fields. The situation is different with a volume flow of electrolyte. The ratio of the concentrations of O and R in the Nernst equation appear in the equation because they are the same as the ratios of the partial pressures of O and R. Without the volume flow the decrease in the partial pressure of O when a current flows in the in external electrical load is determined only by migration of O to the electrode and the conversion of O to R at the electrode so that there are no very high partial pressures present. With the volume flow the supply of O to the working electrode is determined also by the flow. If the rate of supply of O due to the flow and the diffusion are such that for some finite partial pressure of R the ratio of the partial pressures of O and R is very high a nuclear fusion reaction may be ignited involving the charged species O in which case the reaction will be expected to gradually take over the other reactions occurring and the voltages in the Nernst equation and therefore the potential difference between the working electrodes will be proportional to the Gibbs free energy associated with this reaction. Since the power output from this reaction is controlled by the external electrical load RL the rate of the nuclear reaction in terms of the mass of reactants being used up per unit time can be vary small. The materials reacting can be determined by the choice of solute or solvent. For the case of the aqueous solution of sodium hydroxide the reactant at the +ve electrode is expected to be the combination of the sodium nuclei and that at the −ve electrode the combination of oxygen or hydrogen nuclei. With the rate of the nuclear reaction being very low and the choice available of reactants the radiation levels due to the reactions can be very low and the type of radiation can be relatively safe; that is, there need not necessarily be any high energy neutron radiation.
The elements of the electrolytic circuit of this embodiment are such that the apparatus may be built in a very large range of sizes.
While the preferred embodiments have been described in terms of a specific implementation, it should be apparent that the invention can be constructed using other elements for the liquid commutator, the working electrodes, the pump and the container for the electrolyte. The following reference, J. V. Kerkel & A. J. Bard. J. Electroanal. Chem. 54.47.(1974) is hereby incorporated by reference and the skilled person is directed to read this reference to fully understand the discussions herein.
In addition, in methods described herein and/or recited in the claims below, In addition, in methods that may be performed according to preferred embodiments and/or in the claims below, the operations have been described and/or recited in selected typographical sequences. However, the sequences have been selected and so ordered for typographical convenience and are not intended to imply any particular order for performing the operations, unless expressly set forth or those of skill in the art understand a particular ordering to be necessary.

1. An electrolytic system comprising:
a container for an electrolyte arranged such that electrolyte contained therein forms an electrical circuit;
a commutator comprising a pair of input electrodes which are arranged to be immersible in electrolyte contained within the container and further arranged to receive an AC electrical signal at said pair of input electrodes, and to convert said AC electrical signal to a DC signal at two points in the same electrolyte;
a controller for controlling movement of said commutator and a waveform of said applied AC voltage such that said movement of the commutator and said waveform of said applied AC voltage have a predetermined relationship; and
a set of working electrodes arranged to be immersed in the electrolyte contained in the container and further arranged to pass a current therebetween.

2. An electrolytic system as claimed in claim 1 in which the system comprises a pump arranged to pump electrolyte through the system.

3. An electrolytic system as claimed in claim 1 in which the container comprises a series of interconnected tubes.

4. An electrolytic system as claimed in claim 3 in which the ratio of the length of each tube to their cross-sectional area is as large as possible.

5. An electrolytic system as claimed in claim 1 in which the controller is arranged to generate a signal which is used to control the waveform of the AC signal so that it is synchronous with the movement of the commutator.

6. An electrolytic system as claimed in claim 2 in which said DC signal comprising a positive DC voltage, which forms a “+ve virtual electrode” and a negative DC voltage, which forms a “−ve virtual electrode”, the system being further arranged such that said DC signal is applied across the working electrodes and further such that said pump is used to produce a steady flow of electrolyte from said +ve virtual electrode to said −ve virtual electrode and from said −ve virtual electrode to said +ve virtual electrode.

7. An electrolytic system as claimed in claim 6 in which flow of electrolyte from the working electrodes are combined at the input of the pump.

8. An electrolytic system as claimed in claim 1 in which said working electrodes comprise a gas porous membrane.

9. An electrolytic system as claimed in claim 1 in which said working electrodes are arranged such that an ionic species within an electrolyte contained within the container can be connected at the working electrodes such that the resulting faradaic current flowing in the electrolyte flows in the same direction as the flow of electrolyte within the container.

10. A commutator comprising at least a first and a second plate arranged to move relative to one another, one of said plates comprising at least one input port arranged to allow a fluid to enter the commutator and one of said plates comprising at least one output port arranged to allow a fluid to exit the commutator, and at least one of the plates comprising at least one connector, which is capable of connecting said at least one input port to said at least one output port, wherein said plates are arranged such that, as the plates move relative to one another, the connector periodically connects the input port to the output port.

11. A commutator as claimed in claim 10 in which said at least one input port and said at least one output port are provided in said first plate and the connector are provided in said second plate.

12. A commutator as claimed in claim 10 in which said at least one input port comprises a hole passing through said first plate.

13. A commutator as claimed in claim 10 in which the connector comprises a groove in a surface of said second plate.

14. A commutator as claimed in claim 13 in which said groove is a portion of a ring.

15. A commutator as claimed in claim 10 in which said first and second plates are arranged to be held concentrically adjacent one another.

16. A commutator as claimed in claim 10 in which the commutator is configured to produce a signal indicating the relative position of the first and second plate.

17. A method of initiating a fusion reaction comprising:
providing a commutator arranged to allow a fluid to pass therethrough and;
passing a fluid through said commutator,
applying an AC voltage to the fluid on a first side of said commutator;
providing a controller arranged to control said AC voltage such that it has a predetermined relationship to movement of the commutator so as to generate a DC voltage in the fluid on a second side of the commutator; and
applying the DC voltage to a pair of working electrodes such that an electrochemical reaction is initiated therebetween, with said electrochemical reaction being capable of establishing a fusion reaction.

18. A method of plating a component comprising:
providing a commutator arranged to allow a fluid to pass therethrough;
passing a fluid through said commutator applying an AC voltage to the fluid on a first side of the commutator;
providing a controller arranged to control said AC voltage such that it has a predetermined relationship to movement of said commutator so as to generate a DC voltage in the fluid on a second side of said commutator; and
providing a pair of working electrodes immersed in the fluid and situating the component therebetween
applying said DC voltage to said pair of working electrodes such that an electrochemical reaction is initiated therebetween with said electrochemical reaction causing the component to be plated.

19. An electrode comprising an electrode conductor, a gas porous membrane associated with a porous backing such that a space is created that is capable of allowing a fluid to flow therein between said electrode conductor and said gas porous membrane.

20. An electrode as claimed in claim 19 in which said gas porous membrane is mounted upon said porous backing.
